(19) United States
(12) Patent Application Publication
(10) Pub. No.: US 2022/0098928 A1
(43) Pub. Date: Mar. 31, 2022

(54) Ladder With Independently Collapsible Ladder Portions and a Seat

(71) Applicant: Yosef Zaifman, Yavne (IL)

(72) Inventor: Yosef Zaifman, Yavne (IL)

(21) Appl. No.: 17/036,109

(22) Filed: Sep. 29, 2020

(51) Int. Cl. E06C 1/00; A47C 12/02; E06C 1/18

(52) U.S. Cl. CPC E06C 1/005; E06C 1/18; A47C 12/02

(57) ABSTRACT

A ladder with independently collapsible ladder portions, includes a first ladder portion and a second ladder portion attached to the first ladder portion and rotatable away from the first ladder portion. The first ladder portion and second ladder portion each have multiple ladder portion segments situated one adjacent another, each ladder portion segment, in an extended position, having a top surface higher than a top surface of its adjacent segment and a bottom surface lower than the top surface of its adjacent segment. The ladder is configured to be usable as a ladder in a stable manner in a first position in which both the first and second ladder portions are extended and in a second position in which one of the first and second ladder portions is extended and another of the first and second ladder portions is at least partially retracted, the first and second positions being stable.

### FIELD AND BACKGROUND OF THE INVENTION

The invention is in the field of collapsible ladders, and in particular, such ladders that have independently collapsible ladder portions and in some embodiments at least one seating position.

Ladders are used by people who need to work efficiently and conveniently and in a variety of different structural environments.

### SUMMARY OF THE INVENTION

One embodiment is a ladder with independently collapsible ladder portions, comprising a first ladder portion; and a second ladder portion attached to the first ladder portion and rotatable away from the first ladder portion, each of the first ladder portion and second ladder portion comprising multiple ladder portion segments situated one adjacent another, each ladder portion segment, in an extended position, having a top surface higher than a top surface of its adjacent segment and a bottom surface lower than the top surface of its adjacent segment, wherein the ladder is configured to be usable as a ladder in a stable manner in a first position in which both the first and second ladder portions are extended and in a second position in which one of the first and second ladder portions is extended and one other of the first and second ladder portions is at least partially retracted, the first and second positions being stable.

In some embodiments, the ladder is configured to be used as a stool when both the first ladder portion and the second ladder portion are in a fully retracted position. In certain embodiments, the ladder is configured to be adjustable for use in two different states as a stool: in a first state in which top surfaces of all ladder portion segments of the ladder are substantially flush with one another and the seat of the stool is flat and in a second state in which a surface of a first portion of the seat is inclined relative to a surface of a second portion of the seat. In certain embodiments, the substantially v-shaped seat comprises an oblique angle of between about 150 and about 160 degrees.

In certain embodiments, a top surface of each ladder portion segment of the one of the first and second ladder portions that is fully retracted are substantially flush with one another.

In certain embodiments, the ladder further comprises two rubber rings projecting from an external ladder portion segment and configured to contact a wall when the ladder is in use in a position such that one of the first and second ladder positions is in an at least partially retracted position.

In certain embodiments, the second ladder portion is rotatable away from the first ladder portion on an axis of rotation adjacent an innermost top edge of each of the innermost ladder portion segments.

In certain embodiments, the ladder is configured to be usable as a ladder in a stable manner in the second position in which one of the first and second ladder portions is extended and one other of the first and second ladder portions has at least two ladder portion segments that are retracted.

In certain embodiments, the ladder is configured to be usable as a ladder in a stable manner in the second position in which one of the first and second ladder portions is extended and one other of the first and second ladder portions has at least three ladder portion segments that are retracted.

In certain embodiments, a retraction of each of the ladder portion segments of a particular one of the first and second ladder portions is independent of a retraction of any of the other ladder portion segments of the particular one of the first and second ladder portions.

A further embodiment is a multi-purpose collapsible ladder usable as a stool, comprising a first ladder portion; and a second ladder portion attached to the first ladder portion and rotatable away from the first ladder portion, each of the first ladder portion and second ladder portion comprising multiple ladder portion segments situated one adjacent another, each ladder portion segment, in an extended position, having a top higher than a top of its adjacent segment and a bottom lower than the top of its adjacent segment, wherein the ladder is configured to function as a stool when both the first ladder portion and the second ladder portion are in a fully retracted position, wherein a seat of the stool comprises top surfaces of the multiple ladder portion segments of each of the first and second ladder portions.

In certain embodiments, the ladder is configured to be adjustable for use in two different states as a stool: in a first state in which top surfaces of all ladder portion segments of the ladder are substantially flush with one another and the seat of the stool is flat and in a second state in which a surface of a first portion of the seat is inclined relative to a surface of a second portion of the seat. In certain embodiments, in the second state the surface of the first portion of the seat comprises top surfaces of the multiple ladder portion segments of the first ladder portion that are substantially flush with one another and the surface of the second portion of the seat comprises top surfaces of the multiple ladder portion segments of the second ladder portion that are substantially flush with one another. In some embodiments, in the second state the stool is balanced equally such that a first angle that the surface of the first portion makes with a ground is substantially equal to a second angle that the surface of the second portion makes with the ground. In some embodiments, the first angle is between 20 and 30 degrees. In some embodiments, the first state is when both the first ladder portion and the second ladder portion are in a fully retracted position.

In certain embodiments, the ladder is configured to be usable as a ladder in a stable manner in a first position in which both the first and second ladder portions are extended and in a second position in which only one of the first and second ladder portions is extended and the other one of the first and second ladder portions has at least some of its ladder portion segments in a retracted position.

In certain embodiments, for each of the first and second ladder portions each of the ladder portion segments are rigidly affixed to or released from an adjacent ladder portion segment depending upon a position of a pin that is accessible to a user.

A still further embodiment is a ladder and stool combination, comprising a first ladder portion having an extended position and a retracted position; and a second ladder portion having an extended position and a retracted position and attached to and rotatable away from the first ladder portion, the first ladder portion and the second ladder portion each comprising multiple ladder portion segments situated one adjacent another, wherein a retraction of each of the ladder portion segments of a particular one of the first and second ladder portions is independent of a retraction of any of the other ladder portion segments of the particular one of the first and second ladder portions, and wherein a retraction of one of the first and second ladder portions is independent of a retraction of another of the first and second ladder portions, wherein the ladder is configured to be adjustable for use in two different states as a stool: in a first state in which top surfaces of all ladder portion segments of the ladder are substantially flush with one another and the seat of the stool is flat and in a second state in which a surface of a first portion of the seat is inclined relative to a surface of a second portion of the seat, in both the first and second states the first and second ladder portions are in a fully retracted position, wherein the ladder is configured to be usable as a ladder in a stable manner in a first position in which both the first and second ladder portions are extended and in a second position in which one of the first and second ladder portions is extended and another one of the first and second ladder portions is at least partially retracted.

In some embodiments, the ladder further comprises a projecting element projecting from the at least partially retracted other one of the first and second ladder portions and made of a material configured to increase friction between the ladder and a substrate that the ladder leans against.

In certain embodiments, in the first state in which top surfaces of all ladder portion segments of the ladder are substantially flush with one another and the seat of the stool is flat, the ladder and stool combination is still configured to be used a ladder with a single step.

These and other features, aspects and advantages will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is an isometric view of a collapsible ladder with both ladder portions in a fully extended position and open for use, in accordance with one embodiment of the invention;

FIG. 2 is an isometric view of a collapsible ladder with both ladder portions in a fully extended position in a vertical position in preparation for storage, in accordance with one embodiment of the invention;

FIG. 3A is an isometric view of the ladder of FIG. 1 with one of the ladder portion segments of one of the ladder portions in a retracted position and the other ladder portion fully extended, in accordance with one embodiment of the invention;

FIG. 3B is an isometric view of the ladder of FIG. 1 with a different one of the ladder portion segments of one of the ladder portions in a retracted position and the other ladder portion fully extended, in accordance with one embodiment of the invention;

FIG. 3C is an isometric view of the ladder of FIG. 1 with a still different one of the ladder portion segments of one of the ladder portions in a retracted position and the other ladder portion fully extended, in accordance with one embodiment of the invention;

FIG. 4 is an isometric view of the ladder of FIG. 1 with two of the ladder portion segments of one of the ladder portions in a retracted position, in accordance with one embodiment of the invention;

FIG. 5 is an isometric view of the ladder of FIG. 1 with all of the ladder portion segments of one of the ladder portions in a retracted position and the other ladder portion fully extended, in accordance with one embodiment of the invention;

FIG. 6 is an isometric view of the ladder of FIG. 1 with both ladder portions fully retracted and usable as a stool with a flat seat, in accordance with one embodiment of the invention;

FIG. 7 is an isometric view of the ladder of FIG. 1 with both ladder portions fully retracted and usable as a stool with the seat comprising an inclined v-shaped surface, in accordance with one embodiment of the invention;

FIG. 8A is an isometric view of the ladder of FIG. 1 with both ladder portions partially and equally retracted, in accordance with one embodiment of the invention;

FIG. 8B is an isometric view of the ladder of FIG. 1 with both ladder portions partially and equally retracted, in accordance with one embodiment of the invention;

FIG. 8C is an isometric view of the ladder of FIG. 1 with both ladder portions partially and equally retracted, in accordance with one embodiment of the invention;

FIG. 9A is an isometric view of the ladder of FIG. 1 with both ladder portions in the process of being opened, in accordance with one embodiment of the invention;

FIG. 9B is an isometric view of the ladder of FIG. 1 with one ladder segment of one ladder portion extended in a vertical position, in accordance with one embodiment of the invention;

FIG. 10 is an enlarged view of an actuator for a latch mechanism, a button/pin actuator for locking/unlocking and a safety warning indicator;

FIG. 11 is a view of the internal vertical and horizontal components within a ladder portion segment in accordance with one embodiment;

FIG. 12 is a view showing the internal parts of a vertical component of a ladder portion segment focusing on a button/pin mechanism, in accordance with one embodiment; and

FIG. 13 is an exploded view of the button/pin mechanism in accordance with one embodiment.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The invention generally provides a ladder that includes a first ladder portion and a second ladder portion, each of which have multiple ladder portion segments configured to be situated one adjacent the other, each segment, in an extended position, having a top higher than a top of its adjacent segment and a bottom lower than the top of its adjacent segment, and having tops that are substantially flush with one another in a folded or retracted position. The innermost ladder portion segment of the first ladder portion and of the second ladder portion may be configured to rotate away from each other for example on an axis of rotation between them. In certain embodiments, in a collapsed position the ladder is configured to form a seat, which is flat when both the first and second ladder portions are retracted. The seat can be slightly folded on itself when substantially half of the seat is rotated relative to the substantially other half of the seat for example on an axis of rotation to adjust the seat from a flat position to a substantially v-shaped position, also for sitting. The first and second ladder portions can both be extended but in another mode only one of them is extended and the other is retracted or has at least some of its ladder portion segments in a retracted position for certain uses in which the collapsed ladder portion can be leaned against a wall. The ladder may be a compact lightweight adjustable ladder that is a multi-purpose ladder in certain embodiments. The ladder may be made using machining technology. In certain embodiments, the ladder is a multi-purpose ladder.

The principles and operation of a Ladder With Independently Collapsible Ladder Portions and a Seat may be better understood with reference to the drawings and the accompanying description.

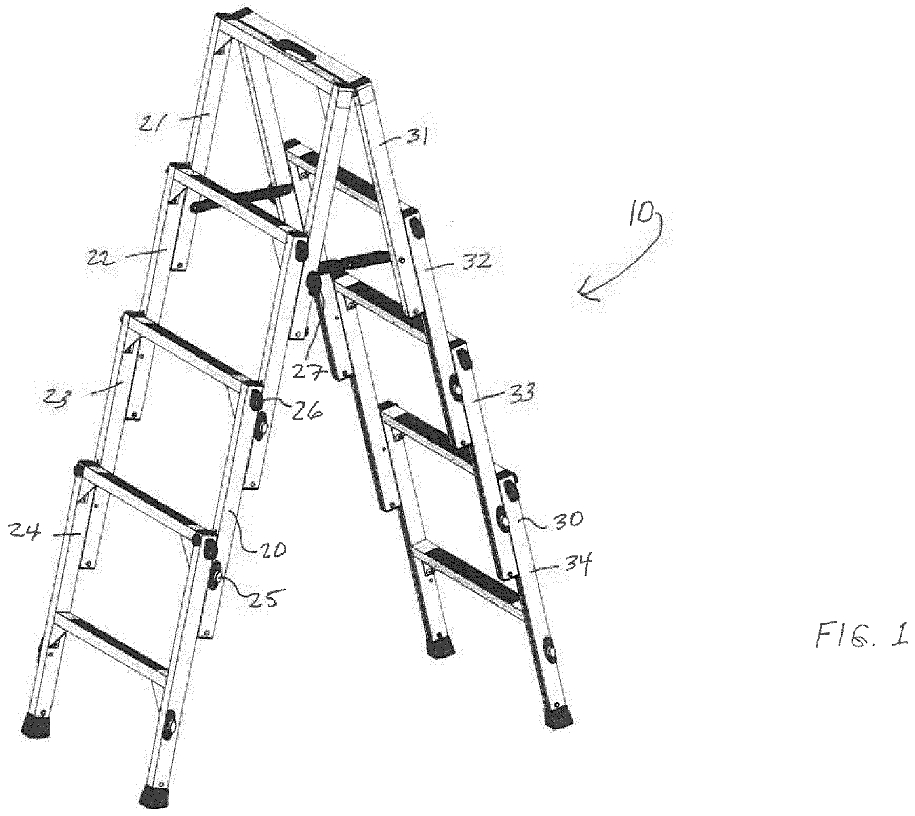

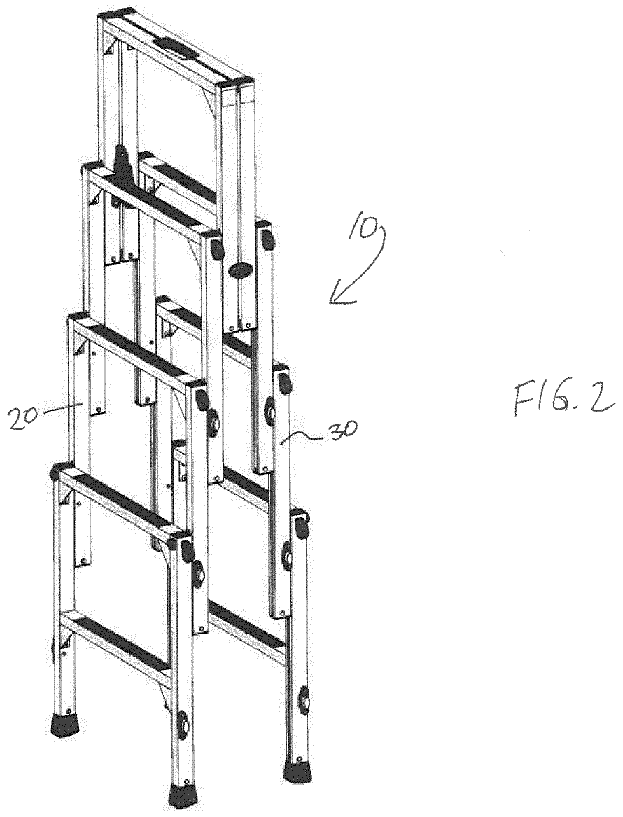

As seen from FIGS. 1-10, in one embodiment, a ladder 10 with independently collapsible ladder portions comprises a first ladder portion 20 and a second ladder portion 30. The two ladder portions are attached to one another at an inner top edge of each. The two ladder portions 20, 30 are also rotatable away from one another. For example, second ladder portion 30 is rotatable away from first ladder portion 20. In one non-limiting implementation, the rotation may occur as a result of an axle 40 situated between a top inner edge of an inner ladder portion segment of first ladder portion 20 and a top inner edge of an inner ladder portion segment of second ladder portion 30. Other alternative ways of implementing the rotation may also be used.

As shown in FIGS. 1-10, each of the first ladder portion 20 and second ladder portion 30 comprises multiple ladder portion segments situated one adjacent another. Each segment represents a rung on the ladder 10. In one non-limiting example shown in FIGS. 1-8, each ladder portion 20, 30 has four segments including one innermost segment and three further segments, one adjacent the other, are radially outward from the innermost segment. The total number of segments in each ladder portion need not be four but rather can range from a minimum of two or three to four or five or six or more. As shown in FIGS. 1-4, the segments may overlap in that each ladder portion segment, for example the ladder portion segments 21, 22, 23, 24 of first ladder portion 20 and the four ladder portion segments 31, 32, 33, 34 of second ladder portion segment 30, in an extended position, has a top surface higher than a top surface of its adjacent segment and a bottom surface lower than the top surface of its adjacent segment.

Each ladder portion segment, for example ladder portion segment 22, may comprise two vertical rods and one horizontal rod for standing (or sitting). The horizontal bar has a top surface which is the top surface of the segment (for example top surface 22A of ladder portion segment 22).

As seen at least from FIGS. 1, 3A-5, ladder 10 is configured to be usable as a ladder in a stable manner (i.e. where the ladder is stable or sturdy or not easily knocked over by the standards of people who regularly use ladders) in at least two positions—a first position in which both the first and second ladder portions 20, 30 are extended and a second position in which one of the first and second ladder portions 20, 30 is extended but the other one of the first and second ladder portions 20, 30 is at least partially retracted, the first and second positions being stable for people to stand on the rungs. This allows the ladder to be positioned closer to the wall than would otherwise be possible because the second ladder portion is no longer fully extended outward. When the ladder portion that is opposite to the side that the user climbs up on is fully extended this necessarily forces the ladder to be distanced from the wall that the user may need to approach with the ladder. There are situations when it is necessary to get closer to the wall with the ladder. Instead of having to distance the ladder a lot from the wall like one does when both ladder portions are fully extended, or such as when using prior art ladders, the second ladder portion 30 can be partially or fully retracted and the ladder 10 can be moved closer to the wall and in fact leaned against the wall by directly leaning the second ladder portion 30 against the wall. Ladder 10 may include a projecting member 99 or element projecting from the second ladder portion 30, for example from a top corner of the second ladder portion 30, for example on each side of the top of the second ladder portion 30 that is at least partially retracted. The projecting member 99 may be made of a material such as rubber and is configured to increase friction between the ladder 10 and a substrate (i.e. the wall) that the ladder 10 leans against.

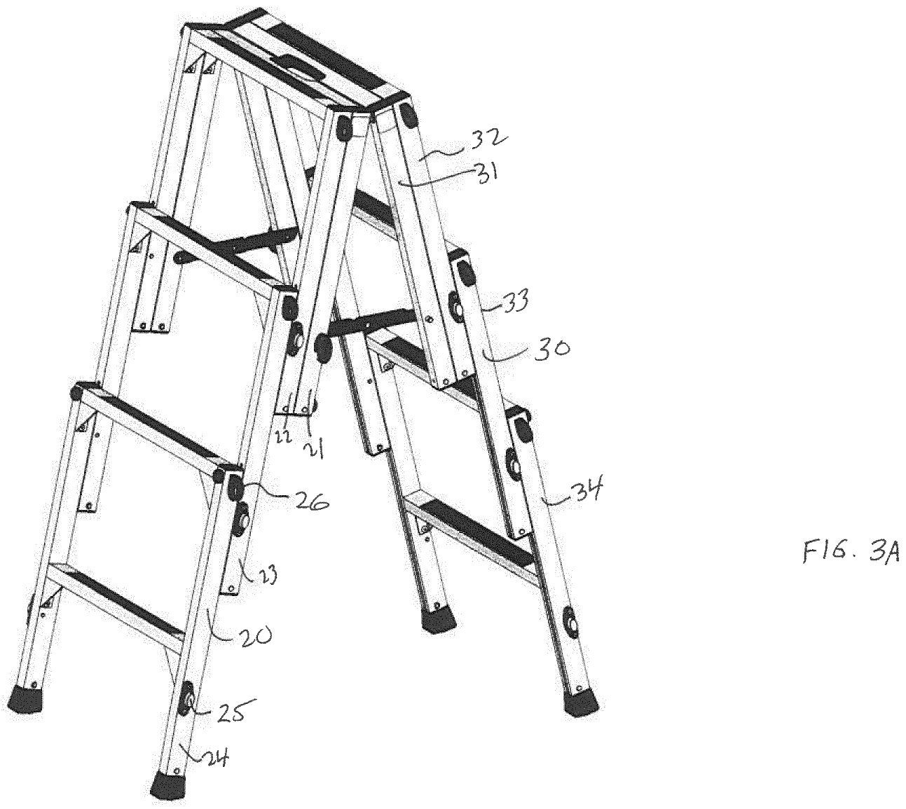

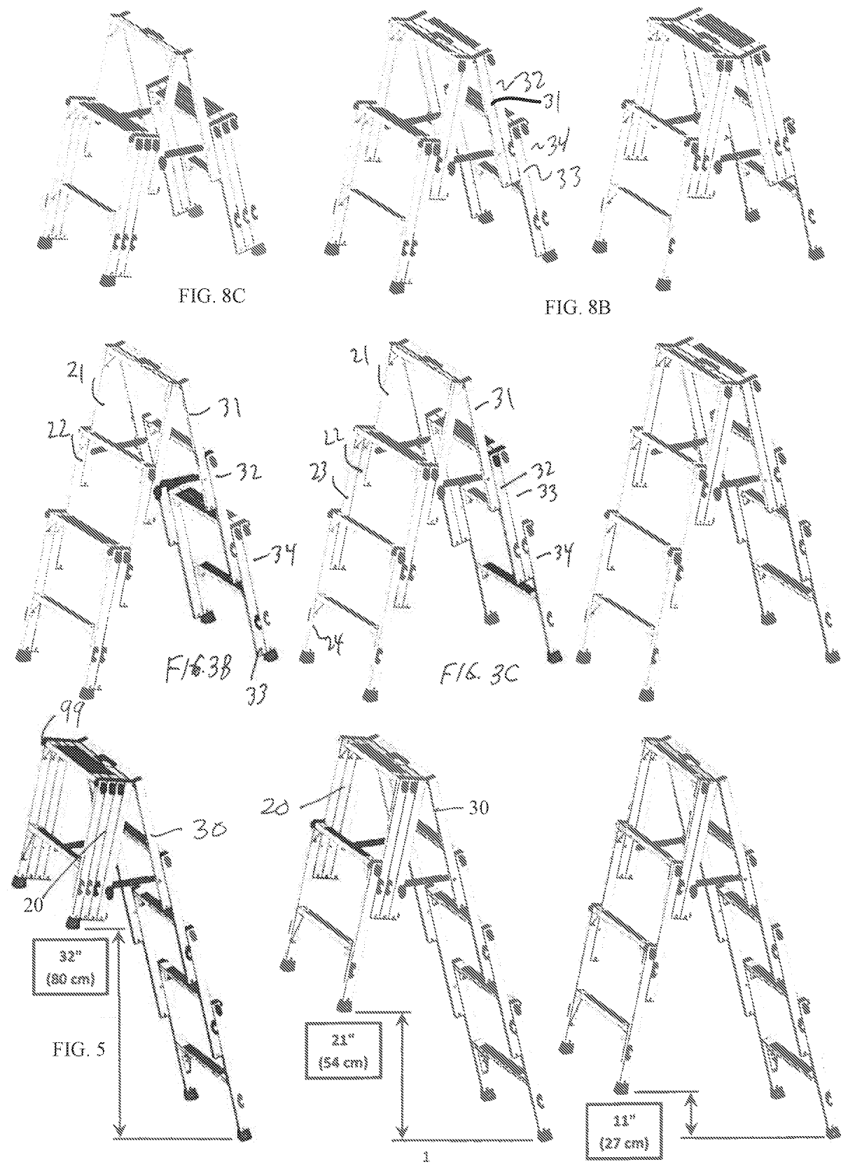

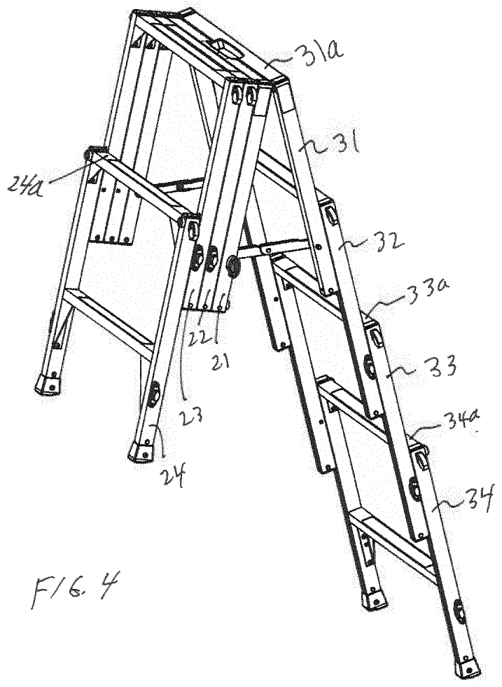

Accordingly, ladder 10 is configured to be usable as a ladder in a stable manner (such that for example someone can walk on the rungs of the ladder) in a second position in which one of the first and second ladder portions is extended and one other of the first and second ladder portions has at least one or at least two or at least three (or all) ladder portion segments that are retracted, as seen for example in FIG. 3A, FIG. 3B, FIG. 3C, FIG. 4, FIG. 5.

In certain embodiments, as seen from FIGS. 1-5, 8A, 8B, 8C, a retraction of each of the ladder portion segments (for example segments 22, 23, 24 or segments 32, 33, 34 which are not the innermost segments) of a particular one of the first and second ladder portions 20, 30 (for example ladder portion 20) is independent of a retraction of any of the other ladder portion segments (segments 22, 23, 24) of that particular one of the first and second ladder portions (for example ladder portion 20). In certain embodiments, it is also independent of the retraction of any of the ladder portion segments (32, 33, 34) of the other ladder portion (for example ladder portion 30). A comparison of FIGS. 3A, 3B and 3C illustrates one example of this since in FIG. 3A only ladder portion segment 32 is retracted and in FIG. 3B only ladder portion segment 34 is retracted (thereby providing a wider standing surface) and in FIG. 3C only ladder portion segment 33 is retracted.

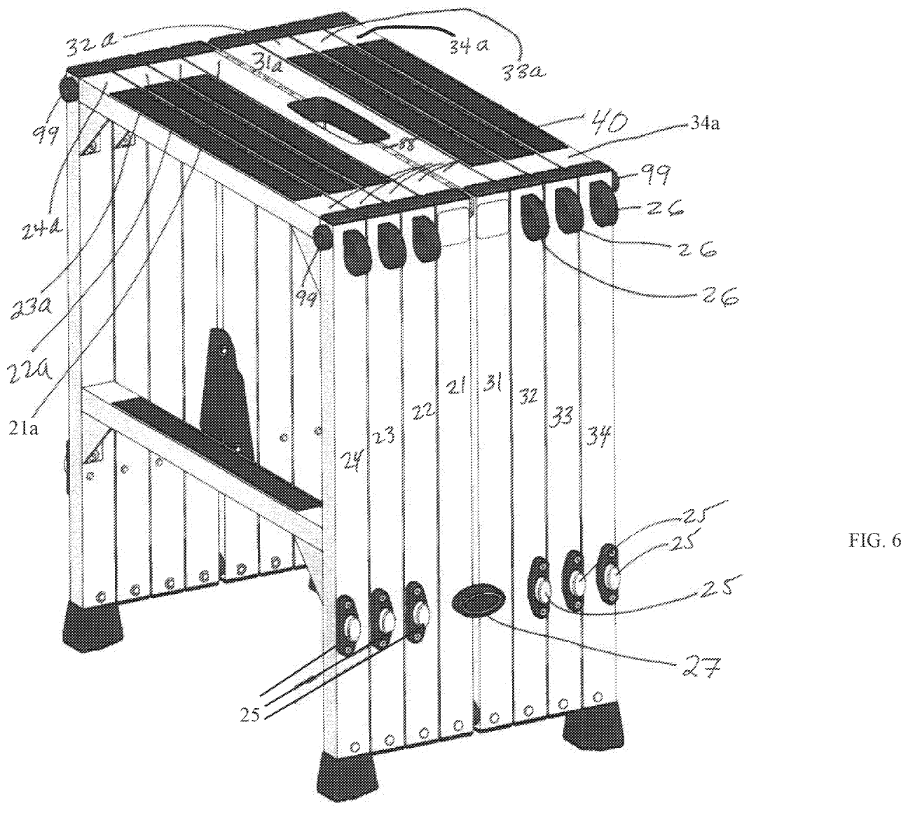

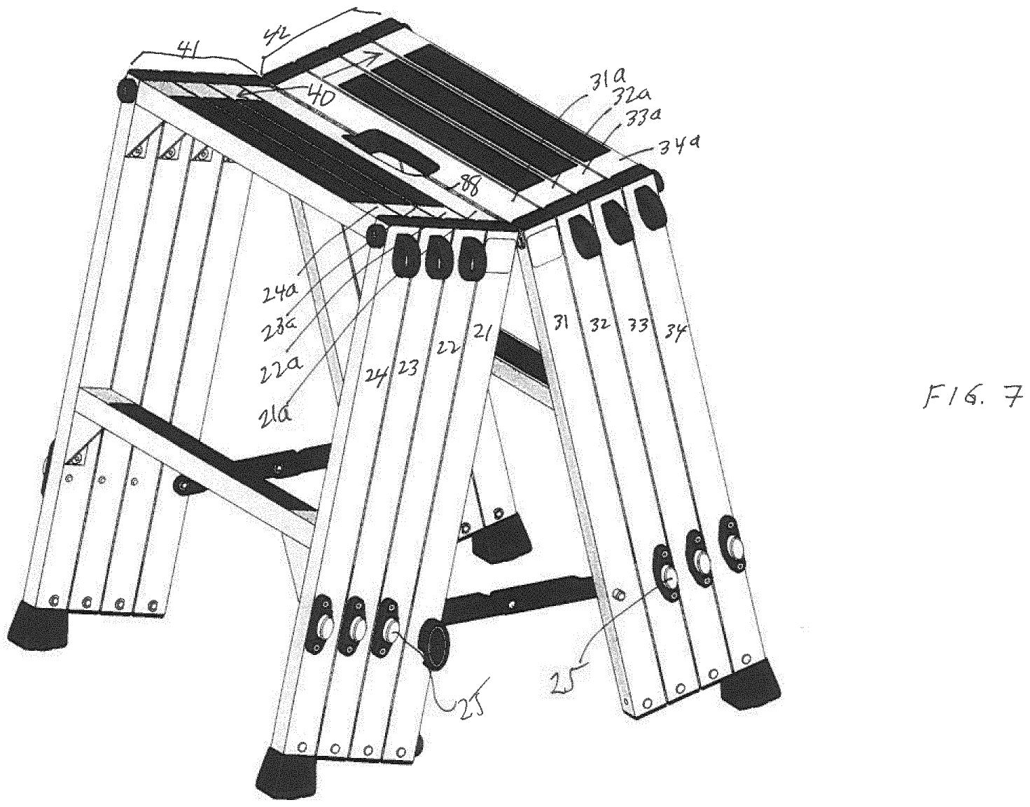

As seen in FIG. 6, ladder 10 may be called a ladder-stool and is configured to be used as a stool when both the first ladder portion 20 and the second ladder portion 30 are in a fully retracted position. As seen from FIG. 6, a seat 40 of the stool comprises top surfaces of the multiple ladder portion segments of each of the first and second ladder portions. As shown in FIG. 6 and FIG. 7, ladder 10 is configured to be adjustable for use in two different states as a stool: in a first state (FIG. 6) in which top surfaces (21a, 22a, 23a, 24a, 31a, 32a, 33a, 34a) of all ladder portion segments (21, 22, 23, 24, 31, 32, 33, 34) of the ladder 10 are substantially flush with one another and the seat 40 of the stool is flat and in a second state (FIG. 7) in which a surface of a first portion 41 of the seat 40 is inclined relative to a surface of a second portion 42 of the seat 40.

In some embodiments, in the second state (FIG. 7) the surface of the first portion 41 of the seat 40 comprises top surfaces of the multiple ladder portion segments (21, 22, 23, 24) of the first ladder portion 20 that are substantially flush with one another and the surface of the second portion 42 of the seat 40 comprises top surfaces of the multiple ladder portion segments (31, 32, 33, 34) of the second ladder portion 30 that are substantially flush with one another. In some positions, for example as shown in FIG. 7, in the second state the stool is balanced equally such that a first angle that the surface of the first portion 41 makes with a ground is substantially equal to a second angle that the surface of the second portion 42 makes with the ground. For example, if the angle between the two portions 41, 42 of seat 40 is 26 degrees then the first angle is 13 degrees and the second angle is 13 degrees.

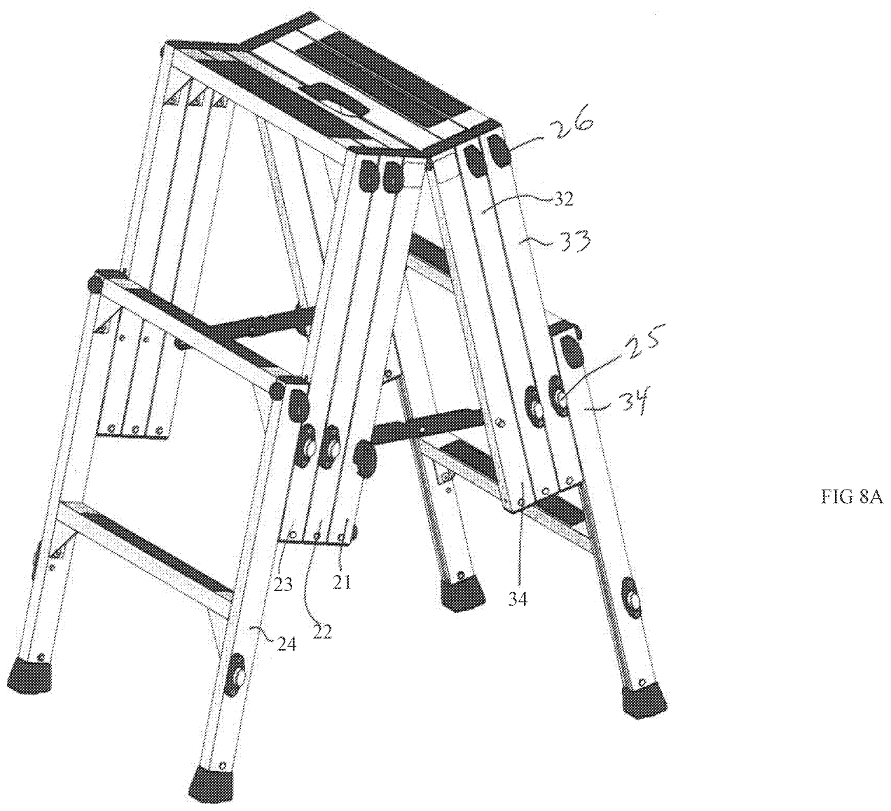

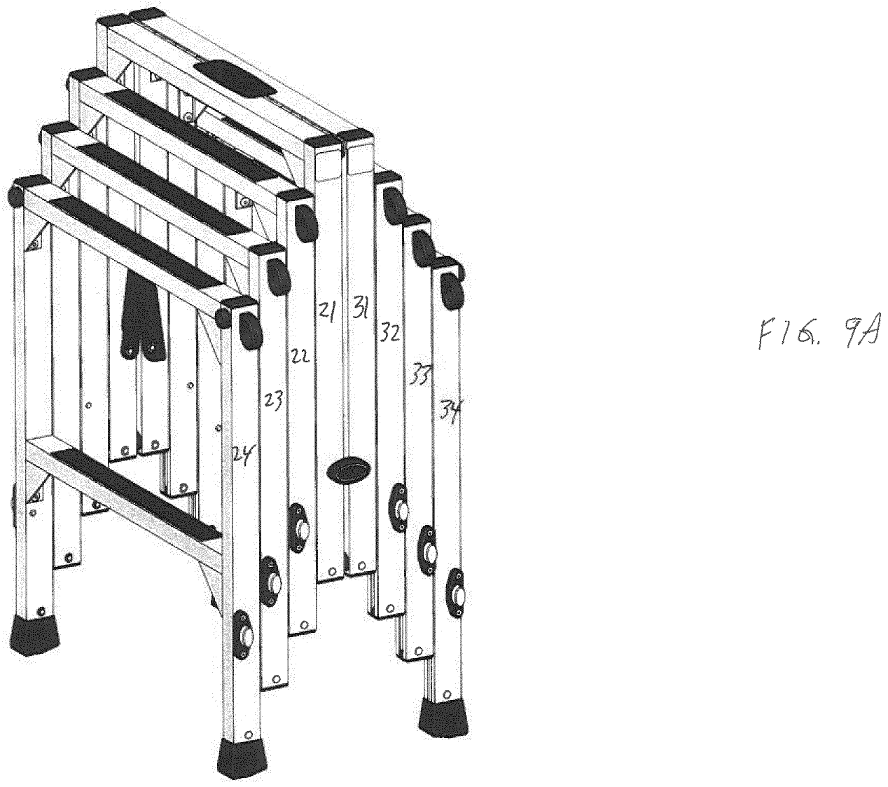

In the position shown in FIG. 8A, the ladder 10 can be used as a short ladder but it can also be used as a tall stool.

In FIG. 7, the seat 40 is substantially v-shaped and a surface of first portion 41 of seat 40 is inclined toward the surface of second portion 42 of seat 40 at a slight angle, for example at an angle of between about 20 and about 30 degrees. In this case, a top surface (21a, 22a, 23a, 24a) of each ladder portion segment 21, 22, 23, 24a of the first ladder portion 20 is substantially flush with one another and likewise a top surface (31a, 32a, 33a, 34a) of each ladder portion segment 31, 32, 33, 34 of the second ladder portion 30 is substantially flush with one another.

As seen from FIG. 5 and FIG. 6, two rubber rings 99 projecting from an external ladder portion segment (24, 34) are configured to contact a wall when the ladder is in use especially in a position in which one of the first and second ladder positions 20, 30 is in an at least partially retracted position or a fully retracted position.

As seen from FIG. 6 and FIG. 7, the second ladder portion 30 is rotatable away from the first ladder portion 20 (and vice versa) on an axis of rotation adjacent an innermost top edge of each of the innermost ladder portion segments 21, 31. In one non-limited example, the axis of rotation may be implemented using an axle 88. Accordingly, an innermost ladder portion segment 21 of the first ladder portion 20 and an innermost ladder portion segment 31 of the second ladder portion 30 that are adjacent to one another are configured to rotate away from each other.

Furthermore, when ladder portions 20, 30 are in fully retracted position and each of the outer locks 27 are rotated as in FIG. 6, ladder 10 is configured as a single step ladder or alternatively in a compact storage position. The fact that ladder 10 can be collapsed for storage has advantages over the prior art. In some non-limiting embodiments, when fully retracted, the maximum length in any dimension is twenty inches (17.5 inches wide and 10 inches thick and 20 inches high) and the weight is only 13.6 pounds. The overall height, if there are four rungs below the top, is 51 inches and the maximum load of this particular embodiment is 330 pounds. Therefore, the entire ladder may conveniently be placed into the luggage compartment of a simple car. In some embodiments, ladder 10 is a compact, lightweight, adjustable multi-purpose ladder.

In an extended position of a ladder portion 20, 30, as seen from FIGS. 1-9, each ladder portion segment, in an extended position, may have a top higher than a top of its adjacent segment and a bottom lower than the top of its adjacent segment.

Ladder 10 is configured to be usable as a ladder in a stable manner (sturdy enough to hold the weight of an adult climbing the ladder) in a first position in which both the first and second ladder portions are extended and also in a second position in which only one of the first and second ladder portions is extended and the other one of the first and second ladder portions has at least some of its ladder portion segments in a retracted position.

The internal parts within a segment will now be described. It should be understood, however, that other connection, locking and release structures or mechanisms may be used to implement the invention other than those described herein.

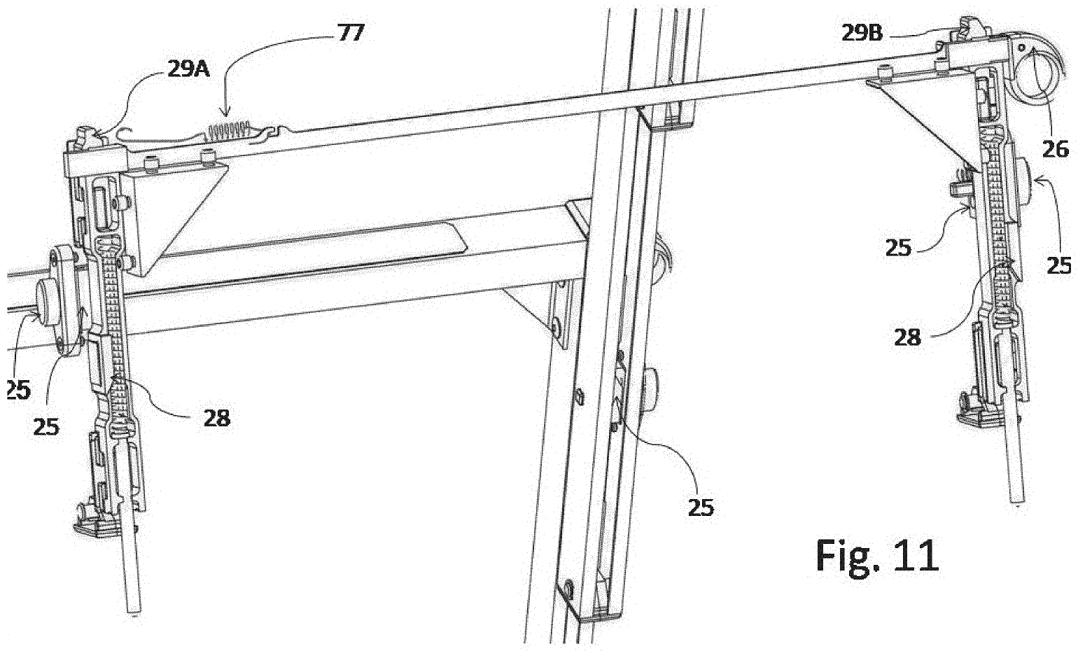

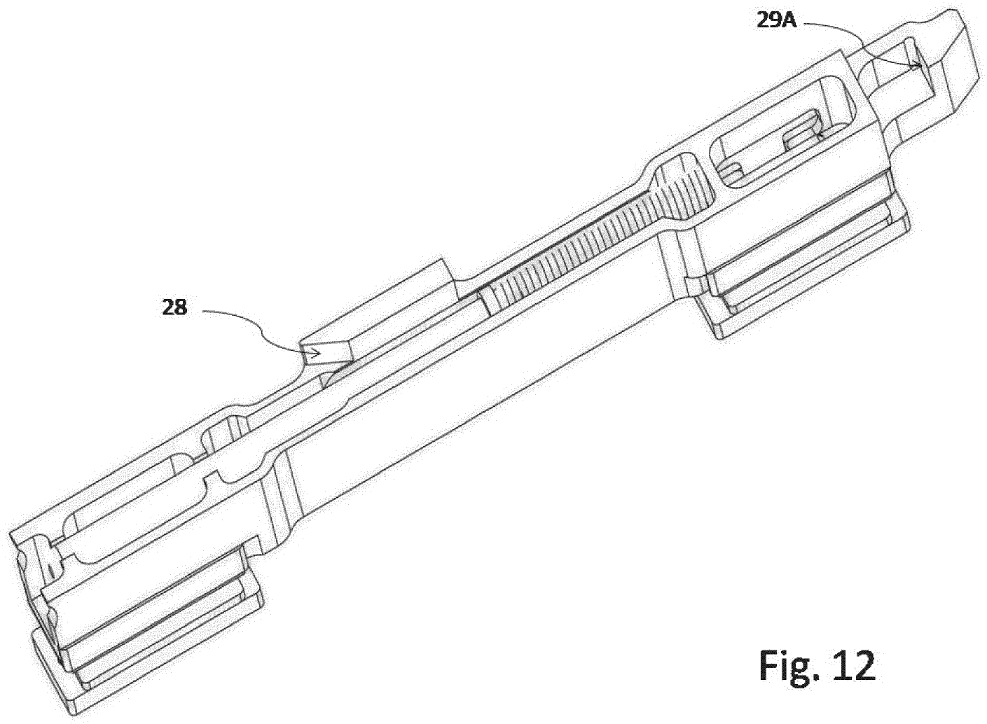

In certain embodiments, as seen from FIGS. 1-10, with respect to each of the first and second ladder portions 20, 30, each of the ladder portion segments (for example segments 21, 22, 23, 24 and 31, 32, 33, 34) are rigidly affixed to or released from an adjacent ladder portion segment depending upon a position of a pin 25 (or button) that is accessible to a user. In addition, as shown in FIG. 11, each of the segments are locked into vertical position by a latch 26

As shown in FIG. 11, latches 26 and pins/buttons 25 work independently of one another. In some embodiments, latches 26 are connected to springs. The pins 25 are also connected to springs (not shown). In one non-limiting implementation, latches 26 work with extension springs 77 and pins/buttons 25 work with compressing springs.

In some implementations, as shown in FIG. 11 when the internally placed hook 29 is in the up position (ladder open), the latches 26 work so as to maintain any of the ladder portion segments (for example the non-innermost ladder portion segments 22, 23, 24 and 32, 33, 34) in locked position. By pulling on latch 26, both hooks 29A, 29B are released and they move downward. Although the drawings depict six latches 26, each on one side of a non-innermost ladder portion segment, in other embodiments the number of latches can vary. In one non-limiting example latches 26 can be situated separately on each side of the segments of ladder 20, which would result in twelve rather than six latches 26 if everything else were to remain the same. Although the drawings depict three ladder portion segments for each ladder portion 20, 30 other than the innermost ladder portion segments 21, 31, in other embodiments, the number of such non-innermost ladder portion segments may be more or less than three, depending on the height of the ladder desired and other factors.

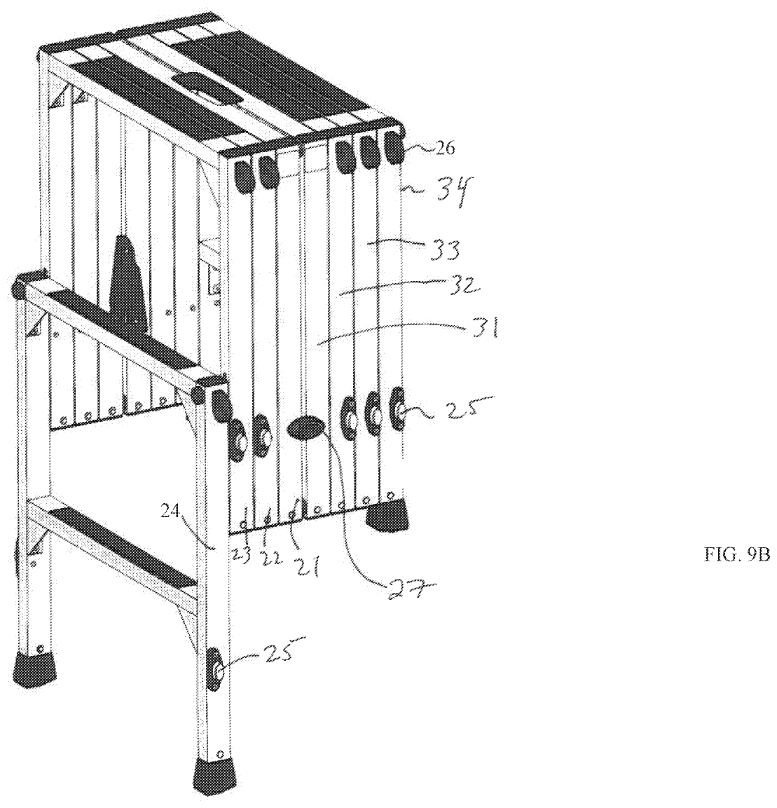

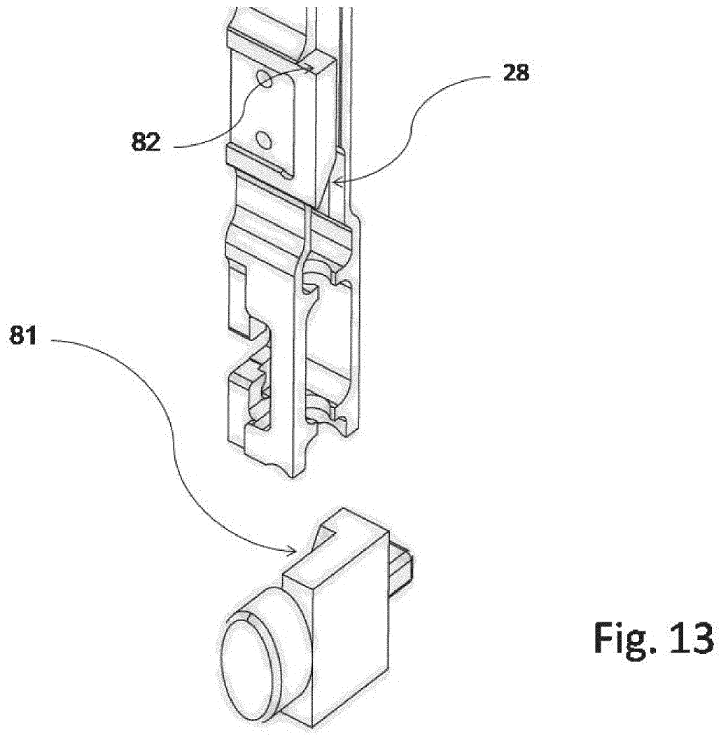

As seen from FIG. 12, on the same vertically positioned part that contains hook 29A is, there is a small inclined ledge 28 (having an angle of about 30 degrees in one non-limiting implementation) that sets the button 25 in motion when this part is lowered to the bottom position as in FIG. 9A (the ladder is almost closed), which is what happens when button 25 is pushed by the user. There are also safety springs (not shown) that are placed internally in the rods of the ladder portion segments that operate during the closing to the position of FIG. 9A. FIG. 9B is not intended to show a functional option but rather an intermediary position as the ladder 10 is completed closed/retracted. FIG. 13 shows further details of the button/pin 25 mechanism including movable surface 81, moving surface 28 and fixation surface 82.

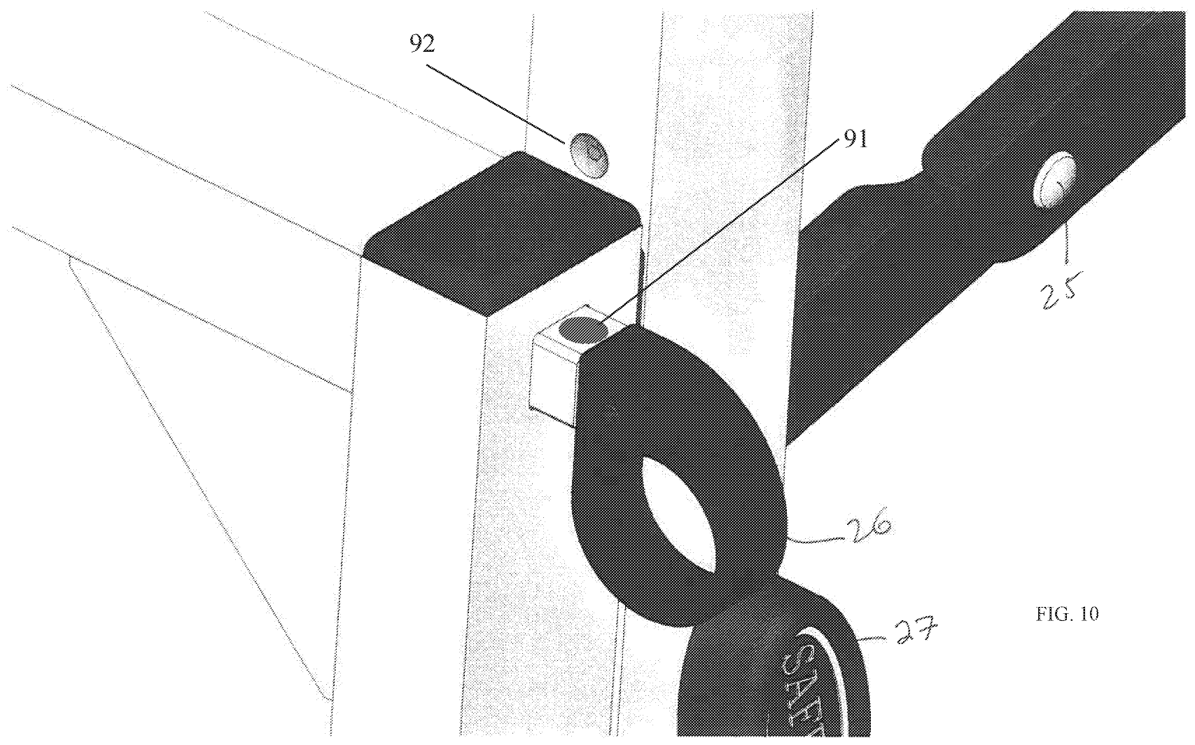

In use from the stored position of ladder 10 to a fully extended position of both ladder portions, open the outer locks 27, separate the two ladder portions 20, 30 from one another and then press in the buttons 25 on each side of each of the segments other than the two innermost segments 21, 31 which in one embodiment shown in the drawings means each of segments 22, 23, 24, 32, 33, 34 (12 buttons in all in one embodiment). The segments will then naturally pop up but one will want to pull them fully up by pulling on the hole in the middle of the top surface of the ladder segments 21, 31 which hole forms a handle for this pulling. After fully extending the ladder portions 20, 30 fully, or as much as desired, one should then check each of the areas around the latches 26 to make sure the safety warning indicator or marker (such as a green circle 92) is exposed indicating the latch 26 had the hooks 20A, 29B caught and the segment is in a locked position. In some embodiments, as shown in FIG. 10, a further indicator is used—for example exposure or appearance of the green circle or other first safety marker 92 coincides with the disappearance of a second safety indicator or marker, such as a red circle 91. In FIG. 10 the first safety marker 92 is the round mark just above the black rectangle representing the beginning of the top surface of the segment shown and the second safety marker 91 is the black circle adjacent latch 26. If one of the segments on each side does not show the first safety marker 92 exposed, then the user should press the rung of the ladder 10 associated with that segment (the rung represents the horizontal portion of the segment). The user can then go up the ladder and work.

To close the ladder 10, for example from its fully extended position, move the ladder portions 20, 30 towards one another until they are substantially parallel to one another, lock outer locks 27 and then pull all the latch tabs 26 of all the ladder portion segments whose adjacent (in the more radially inner direction) ladder portion segments you want to retract. For example, to retract ladder portion segments 22, 32 pull latches of ladder portion segments 24, 34. This may result in ladder 10 being in the state depicted in FIG. 9A. To put the ladder 10 in the fully retracted position of FIG. 6, for example for sitting or storing, one may need to finish the process by pushing down on the tops of the ladder portion segments (to overcome the force of the safety springs).

Although the illustrated embodiments have been implemented using latches and pins, one skilled in the art would understand that other connecting and lock means may be utilized.

It should be understood that while the number of ladder portion segments depicted in the drawings and discussed is four, this is by no means required—the number of segments may be fewer than four and may be more than four.

Another embodiment is a ladder and stool combination, comprising a first ladder portion having an extended position and a retracted position; and a second ladder portion having an extended position and a retracted position and attached to and rotatable away from the first ladder portion, the first ladder portion and the second ladder portion each comprising multiple ladder portion segments situated one adjacent another, wherein a retraction of each of the ladder portion segments of a particular one of the first and second ladder portions is independent of a retraction of any of the other ladder portion segments of the particular one of the first and second ladder portions, and wherein a retraction of one of the first and second ladder portions is independent of a retraction of another of the first and second ladder portions, wherein the ladder is configured to be adjustable for use in two different states as a stool: in a first state in which top surfaces of all ladder portion segments of the ladder are substantially flush with one another and the seat of the stool is flat and in a second state in which a surface of a first portion of the seat is inclined relative to a surface of a second portion of the seat, in both the first and second states the first and second ladder portions are in a fully retracted position, wherein the ladder is configured to be usable as a ladder in a stable manner in a first position in which both the first and second ladder portions are extended and in a second position in which one of the first and second ladder portions is extended and another one of the first and second ladder portions is at least partially retracted.

In any of the embodiments described herein, when the ladder is retracted such that the top surfaces of all ladder portion segments of the ladder are substantially flush with one another and the seat of the stool is flat, the ladder and stool combination is still configured to be used a ladder with a single step, as shown in FIG. 6. Thus ladder 10 is very versatile for this additional reason. In additional, it is possible to use ladder 10 as a ladder in the positions of FIGS. 8A, 8B, 8C.

While the invention has been described with respect to a limited number of embodiments, it will be appreciated that many variations, modifications and other applications of the invention may be made. Therefore, the claimed invention as recited in the claims that follow is not limited to the embodiments described herein.

1. A ladder with independently collapsible ladder portions, comprising:
a first ladder portion; and
a second ladder portion attached to the first ladder portion and rotatable away from the first ladder portion,
each of the first ladder portion and the second ladder portion comprising multiple ladder portion segments situated one adjacent another, each of the multiple ladder portion segments having a horizontal bar,
each of the multiple ladder portion segments defined such that when a particular ladder portion segment retracts upward alongside an adjacent particular ladder portion segment, the horizontal bar of the particular ladder portion segment becomes positioned alongside the horizontal bar of the adjacent particular ladder segment and the top surface of the horizontal bar of the particular ladder portion segment becomes positioned alongside the top surface of the horizontal bar of the adjacent particular ladder segment, a distance from the horizontal bar of the particular ladder portion segment to the horizontal bar of the adjacent particular ladder portion segment corresponding to one step of the ladder,
in a fully extended position before the particular ladder portion segment retracts upward, a bottom surface of the adjacent particular ladder portion segment is lower than the horizontal bar of the particular ladder portion segment,
wherein the ladder is configured to be usable to walk on in a stable manner in a first position in which both the first and second ladder portions are extended and in a second position in which one of the first and second ladder portions is extended and one other of the first and second ladder portions is at least partially retracted, the ladder being stable in the first and second positions.

2. The ladder of claim 1, wherein the ladder is configured to be used as a stool when both the first ladder portion and the second ladder portion are in a fully retracted position.

3. The ladder of claim 2, wherein the ladder is configured to be adjustable for use in two different states as a stool: in a first state in which top surfaces of all ladder portion segments of the ladder are substantially flush with one another and a seat of the stool is flat and in a second state in which a surface of a first portion of the seat is inclined relative to a surface of a second portion of the seat.

4. The ladder of claim 3, wherein the seat is substantially v-shaped seat and comprises an oblique angle of between about 150 and about 160 degrees.

5. The ladder of claim 1, wherein the top surface of the first horizontal bar is positioned alongside the top surface of the second horizontal bar so as to be substantially flush with one another.

6. The ladder of claim 1, further comprising two rubber rings projecting from an external ladder portion segment and configured to contact a wall when the ladder is in use in a position such that one of the first and second ladder portions is in an at least partially retracted position.

7. The ladder of claim 1, wherein the second ladder portion is rotatable away from the first ladder portion on an axis of rotation that is adjacent an innermost top edge of an innermost ladder portion segment.

8. The ladder of claim 1, wherein the ladder is configured to be usable as a ladder in a stable manner in the second position of the ladder in which one of the first and second ladder portions is extended and one other of the first and second ladder portions has at least two ladder portion segments that are retracted.

9. The ladder of claim 1, wherein the ladder is configured to be usable in the stable manner in the second position in which one of the first and second ladder portions is extended and one other of the first and second ladder portions has at least three ladder portion segments that are retracted.

10. The ladder of claim 1, wherein a retraction of each of the ladder portion segments of a particular one of the first and second ladder portions is independent of a retraction of each other ladder portion segments of the particular one of the first and second ladder portions.

11. A multi-purpose collapsible ladder usable as a stool, comprising:
a first ladder portion; and
a second ladder portion attached to the first ladder portion and rotatable away from the first ladder portion,
each of the first ladder portion and second ladder portion comprising multiple ladder portion segments situated one adjacent another, each of the multiple ladder portion segments having a horizontal bar,
each of the multiple ladder portion segments defined such that when a particular ladder portion segment retracts upward alongside an adjacent particular ladder portion segment, the horizontal bar of the particular ladder portion segment becomes positioned alongside the horizontal bar of the adjacent particular ladder segment and the top surface of the horizontal bar of the particular ladder portion segment becomes positioned alongside the top surface of the horizontal bar of the adjacent particular ladder segment, a distance from the horizontal bar of the particular ladder portion segment to the horizontal bar of the adjacent particular ladder portion segment corresponding to one step of the ladder,
in a fully extended position before the particular ladder portion segment retracts upward, a bottom surface of the adjacent particular ladder portion segment is lower than the horizontal bar of the particular ladder portion segment,
wherein the ladder is configured to function as a stool when both the first ladder portion and the second ladder portion are in a fully retracted position,
wherein a seat of the stool comprises top surfaces of the multiple ladder portion segments of each of the first and second ladder portions.

12. The ladder of claim 11, wherein the ladder is configured to be adjustable for use in two different states as a stool: in a first state in which top surfaces of all ladder portion segments of the ladder are substantially flush with one another and the seat of the stool is flat and in a second state in which top surfaces of all ladder portion segments of a first portion of the seat is inclined relative to top surfaces of all ladder portion segments of a second portion of the seat.

13. The ladder of claim 12, wherein in the second state the surface of the first portion of the seat comprises top surfaces of the multiple ladder portion segments of the first ladder portion that are substantially flush with one another and the surface of the second portion of the seat comprises top surfaces of the multiple ladder portion segments of the second ladder portion that are substantially flush with one another.

14. The ladder of claim 12, wherein in the second state the stool is balanced equally such that a first angle that the top surfaces of all ladder portion segments of the first portion makes with a ground surface is substantially equal to a second angle that the top surfaces of all ladder portion segments of the second portion makes with the ground surface.

15. The ladder of claim 14, wherein the first angle is between 20 and 30 degrees.

16. The ladder of claim 12, wherein the first state is when both the first ladder portion and the second ladder portion are in a fully retracted position.

17. The ladder of claim 11, wherein the ladder is configured to be usable as a ladder in a stable manner in a first position in which both the first and second ladder portions are extended and in a second position in which only one of the first and second ladder portions is extended and another one of the first and second ladder portions has at least some ladder portion segments in a retracted position.

18. The ladder of claim 11, wherein for each of the first and second ladder portions each of the ladder portion segments are rigidly affixed to or released from an adjacent ladder portion segment depending upon a position of a pin that is accessible to a user.

19. The ladder of claim 1,
wherein a retraction of each of the ladder portion segments of the multiple ladder segment portions of the first ladder portion is independent of a retraction of any other ladder portion segment of the multiple ladder segment portions of the first ladder portion, and wherein a retraction of the first ladder portion is independent of a retraction of the second ladder portion,
wherein the ladder is configured to be adjustable for use in two different states as a stool: in a first state in which top surfaces of all ladder portion segments of the ladder are substantially flush with one another and a seat of the stool is flat and in a second state in which a surface of a first portion of the seat is inclined relative to a surface of a second portion of the seat, in both the first and second states the first and second ladder portions are in a fully retracted position.

20. The ladder and stool combination of claim 19, further comprising a projecting element projecting from the at least partially retracted other one of the first and second ladder portions and made of a material configured to increase friction between the ladder and a substrate that the ladder leans against.

21. (canceled)
